(19) United States
(12) Patent Application Publication
(10) Pub. No.: US 2021/0409196 A1
(43) Pub. Date: Dec. 30, 2021

(54) Secure Key Storage Systems Methods And Devices

(71) Applicant: Sectigo, Inc., Roseland, NJ (US)

(72) Inventor: Alan Grau, Des Moines, IA (US)

(21) Appl. No.: 17/364,737

(22) Filed: Jun. 30, 2021

Related U.S. Application Data
(60) Provisional application No. 63/046,138, filed on Jun. 30, 2020.

(51) Int. Cl. H04L 9/08; H04L 9/06

(52) U.S. Cl. CPC H04L 9/085; H04L 9/0643; H04L 9/0819; H04L 9/0894

(57) ABSTRACT

The disclosure is related to systems and methods for obfuscating keys. In one step the system divides a storage root key into at least two chunks. In another step the system processes each of the at least two chunks with at least one obfuscation algorithm to create at least two obfuscated chunks. In a further step the system stores each of the at least two obfuscated chunks in a storage file. In a further step, user keys are encrypted with the storage root key.

### CROSS-REFERENCE TO RELATED APPLICATION(S)

This application claims priority to U.S. Provisional Patent Application No. 63/046,138, filed Jun. 30, 2020 and entitled “Secure Key Storage,” which is hereby incorporated by reference in its entirety under 35 U.S.C. § 119(e).

### TECHNICAL FIELD

The disclosure relates to secure storage of cryptographic keys, authentication tokens, shared secrets, and other sensitive or private information.

### BACKGROUND

Prior known systems for securing Internet of Things (“IoT”) and other electronic devices that do not provide a hardware-based method of security for storing cryptographic keys and other sensitive information are not adequate and are vulnerable to hackers and to the data on the devices being read if the device is stolen or if the device is compromised by hackers.

Various other known systems include hardware secure elements (“SE”s) including Hardware Security Modules (“HSM”s) and/or Trusted Platform Modules (“TPM”s). SEs provide hardware based secure key storage and perform cryptographic operations using a physically separate processor that is hardened against cyberattacks. In these known systems a host computer uses the SEs to generate keys, store keys, and perform cryptographic operations using the keys. These keys are stored on a physically separate processor. In these systems, if the host computer is stolen or infected with malware or is otherwise compromised the keys are still protected, and as a result the data encrypted with these keys remains protected.

In systems lacking a SE the keys must be stored on the device, such as on a hard drive, in flash memory, or other memory type. The keys can be used to encrypt data stored on the device and to encrypt data communications between the device and other computing devices. The memory, in which the keys are stored, is unprotected and can easily be read. Encrypting data is not enough to protect the data because the encryption keys must also be stored on the device. Encrypting the keys is also insufficient, as this requires a Key Encryption Key to encrypt the keys, and the Key Encryption Key must be stored on the device in unencrypted format.

In these systems, lacking a SE, the key(s) are either hardcoded into the firmware image or stored on the device along with other data. If an attacker can gain access to the firmware or device, or gain access to the memory on the device via a cyberattack, the key(s) can be discovered and read. As would be recognized, gaining access to the firmware is not a difficult endeavor as the firmware can be read directly from the device, accessed by a hacker if the device is compromised through a cyberattack, or in some cases can be accessed from a manufacturer's website or from the manufacturer's firmware update server.

There is a need in the art for improved systems, devices, and methods for securing key(s) and other sensitive data on devices without additional hardware components.

### BRIEF SUMMARY

A system of one or more computers or computing devices can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One Example includes a method for obfuscating keys including dividing a key (e.g., a storage root key) into at least two initial chunks. The method also includes processing each of the at least two initial chunks with at least one obfuscation algorithm to create at least two obfuscated chunks. The method also includes storing each of the at least two obfuscated chunks in storage files, one file for each of the at least two chunks. Other embodiments of this Example include corresponding computer systems, devices, and computer programs recorded on one or more computer storage devices, each configured to perform the actions of the methods.

Implementations of this Example may include one or more of the following features. The method where the storage file includes random bits of data. Implementations of the described techniques may include hardware, a method or process, or computer software on a computer-accessible medium.

Various Examples of the disclosure relate to a method for protecting a Storage Root Key (“SRK”). In these implementations, the SRK is broken into multiple initial chunks and the chunks are obfuscated. In some implementations, the method includes one or more application programming interfaces (“APIs”) to allow a user to insert random data into the obfuscated chunks and/or to allow a user to insert hardware specific data into the obfuscated chunks. In various implementations, a user may be able to customize the size and number of chunks. Further, users may be able to customize the obfuscation algorithm applied to the chunks.

In some implementations, the SRK is never stored on the disk in plaintext format. That is, the SRK is never on the disk in an unencrypted and/or unobfuscated format. In some implementations, the method stores a hash value for the key. In some implementations, the method may further include validating the key using the hash value, for example, validating the integrity of the SRK stored on the disk in an obfuscated format.

In some implementations, the method allows a user to specify the SRK. In further implementations, a user may instruct the system to generate a random SRK.

Further Examples of the disclosure are related to a method for protecting user keys using an SRK. In these implementations, user keys are encrypted with the SRK. In certain implementations, one or more APIs allow a user to store a key and/or retrieve a key. In some implementations, the method allows for verifying a user before allowing the user to retrieve a key, that is to ensure that the request to retrieve the key is from the owner of the key.

In some implementations, the method ensures that user keys are never stored on the disk in plaintext. That is, user keys are never found on the disk in an unencrypted format. In some implementations, the method stores a hash value to validate the integrity of user keys and the SRK stored on the disk in an encrypted format.

Further Examples of the disclosure are related to a system for storing and protecting user keys, for example, using an SRK. The system may include an Internet of Things (“IoT”) device, a disk within the IoT device, a module disposed on the disk including at least one storage root key and at least one user key, and at least one API in communication with the disk, where the storage root key is encrypted with a static key encryption key, and where the storage root key is stored on the disk in an obfuscated format and in an obfuscated location.

In certain implementations of this Example, the at least one API allow a user to store a key and/or retrieve a key. In some implementations, the at least one API verifies the user is an owner of the user key before allowing the user to retrieve the user key.

In some implementations of this Example, the system further includes a library comprising a plurality of encrypted and stored user keys. In some implementations, the system hashes the library to create a hash value and wherein the hash value is stored on the disk for validating the plurality of encrypted and stored user keys in the library. In some implementations, the system where the at least one storage root key and the at least one user key are not stored on the disk in an unencrypted format.

Further Examples of the disclosure are related to a method for protecting one or more keys including encrypting a first key with a second key, storing the first key in an encrypted format on a disk, and storing the second key on the disk in an obfuscated format and an obfuscated location. Other embodiments of this Example include corresponding computer systems, devices, and computer programs recorded on one or more computer storage devices, each configured to perform the actions of the methods.

Implementations of these Examples may include one or more of the following features. The method where the first key and the second key are not stored on the disk in an unencrypted format. In some implementations, the method may further include hashing the second key to create a hash value, storing the hash value on the disk, and validating the second key using the hash value. The method where the second key is stored in a secure element. The method where the secure element is a trusted platform module. The method where the secure element comprises a trusted execution environment. Implementations of the described techniques may include hardware, a method or process, or computer software on a computer-accessible medium.

Still further, certain Examples relate to a method for protecting the SRK. In these implementations, the SRK is stored in a secure element such as a trusted platform module. In certain of these implementations, the SRK is stored in a “secure world” on a system with a Trusted Execution Environment such as ARM Trustzone™.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a schematic representation of a computing device implementing a storage system, according to one implementation.

FIG. 1B is a schematic diagram of a Secure Key Storage module of the storage system, according to one implementation.

2A is a flow chart of the system, according to one implementation.

FIG. 2B is a flow chart of the system, according to one implementation.

FIG. 2C is a flow chart of the system, according to one implementation.

FIG. 3 is a flow chart of an obfuscation module, according to one implementation.

FIG. 4 is a schematic depiction of key encryption processes, according to one implementation.

FIG. 5 is a flow diagram of a hash function, according to one implementation.

FIG. 6 is a flow diagram illustrating various APIs, according to one implementation.

### DETAILED DESCRIPTION

Disclosed herein are various devices, systems, and methods for storing encryption keys and other secrets on devices without a SE, TPM, or other hardware based secure storage mechanisms. In various implementations, the devices, systems, and methods described herein relate to storing sensitive information via software obfuscation. Further in some implementations, a storage root key (“SRK”) can be used to decrypt other keys, and in devices that do not have a SE, a method for securely storing the SRK is provided.

The various systems and related methods and devices disclosed provide for the ability to protect cryptographic keys and other sensitive information if a device is infected with malware, if the device is stolen, and/or if the firmware for the device is stolen or discovered. As would be appreciated, the firmware can be stolen or discovered when the device firmware is stored on public webservers to allow customers to update the firmware on the device or is otherwise accessible on network connected computing infrastructure. According to an aspect of the disclosed technology, in various implementations, an electronic or computer data storage system provides portable libraries that allow users to securely store encryption keys and/or other secrets on devices without a TPM or other hardware based secure storage mechanism.

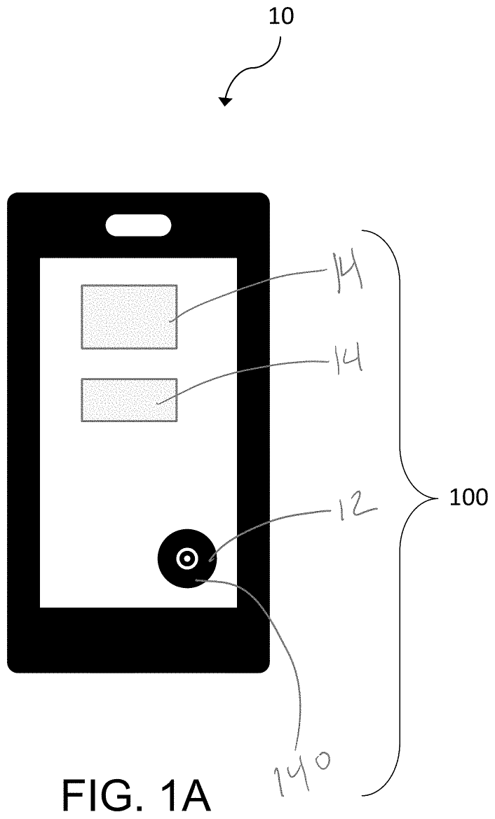

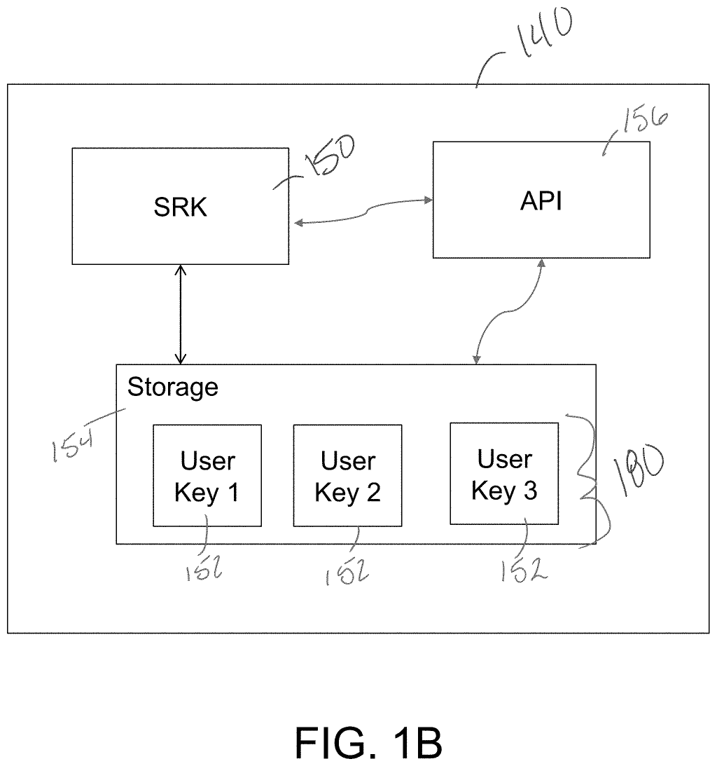

Referring to the drawings, FIG. 1A depicts a computing device 10 that implements a storage system 100 according to various implementations. The computing device 10 is an electronic device that uses and/or stores cryptographic keys and/or other sensitive information that a user may wish to remain private. In some cases, the computing device 10 (also referred to herein as the “device”) does not provide a hardware-based method of security for storing cryptographic keys and other sensitive information. In some cases, the computing device 10 may include a hardware-based storage security system that is not in use. In some cases, the computing device 10 includes a hardware-based storage security system that is used together with one or more aspects of the technology disclosed herein. According to various implementations, the computing device 10 can be a computer (e.g., a desktop, laptop, server), a smartphone, an Internet of Things (“IoT”) device, or another type of electronic device with a computer storage medium and processing capability.

In certain implementations, the system 100 provides a library constructed and arranged for error reporting and logging within the system 100. A crypto library may also be provided that is constructed and arranged to conduct hashing and encryption operations. Further, the system 100 provides a Secure Key Storage (“SKS”) module 140 constructed and arranged to store and perform a variety of security methods and devices. In FIG. 1A, the SKS module 140 is depicted as being stored on the device's electronic or computer storage medium 12 or disk 12.

In various implementations, the system 100 operates on a device 10 having at least a disk 12, flash memory 12, or other storage technology 12 and/or other processing components as would be understood. In some cases, the storage medium 12 includes any suitable electronic or computer storage technology. Examples include, but are not limited to, electromechanical storage such as hard disks and solid-state storage such as flash memory, which can be local or remote, such as cloud-based, as would be appreciated. The system 100 further includes one or more applications 14.

FIG. 1B is a schematic view of the SKS module 140 according to various implementations. In some cases, the SKS module 140 requires two levels of keys. In various implementations, the module 140 creates and manages a SRK 150. In various implementations, the SRK 150 is encrypted with a Static Key Encryption Key (“SKEK”) that is hardcoded into the code. In some implementations, the SRK 150 is an AES256 key, or other encryption key that would be appreciated by those of skill in the art.

Additionally, in some implementations, a user may be allowed to configure the length of the SRK 150, such as via a #defines directive or other software coding technique as would be appreciated. In various implementations, a user may be provided with the ability to insert random bits of data into the SRK 150 to ensure that each SRK 150 is unique. By inserting random bits of data into the SRK 150, the SRK 150 becomes more secure, in that knowledge of an obfuscation algorithm will not allow for easy discovery of the SRK 150 or discovery of the SRK 150 for one device will not allow compromise of another device using the same algorithm. In still further implementations, an API can also be used to tie the SRK 150 to device specific data (i.e. a serial number read from hardware).

The SRK 150 is stored in an obfuscated format and in an obfuscated location. The SRK 150 is obfuscated when stored on either the disk 12 or the memory 12 of a device 10. Obfuscation of the SRK 150 prevents discovery of the SRK 150 in systems 100 lacking a hardware based secure key storage. In these and other implementations, as an increased security measure, the SRK 150 will never be available on the disk 12 in an unencrypted format.

Hardware based secure key storage devices are recognized in the art, but as is appreciated, the hardware-based solutions require additional hardware to be added to, which can increase the cost and expense of a device 10. Aspects of the disclosed technology can in various examples be implemented with existing hardware, thus providing additional security without the additional cost usually associated with hardware-based secure key storage.

In some implementations, the Secure Key Storage (“SKS”) module 140 manages user keys 152, certificates, and/or other secrets. For consistency and clarity, the system 100 is described herein by referencing a user key(s) 152 as the item to be secured and stored, but it is contemplated that the system 100 may be used to secure and store additional or alternative items, including but not limited to certificates, passwords, and secrets.

In these implementations, the user keys 152 are sealed and stored on the disk 12 or other storage medium 12 in sealed storage 154. In some implementations, the user keys 152 may be stored in the aggregate or otherwise in a comingled fashion in a library. By sealing the user keys 152 they are encrypted using the SRK 150 before storage. The user keys 152 are never stored on the disk 12 in an unencrypted format. In various implementations, the sealed storage 154 is stored in memory in an obfuscated format.

In further implementations, the SKS module 140 manages obfuscating and de-obfuscating the SRK 150 and sealing and unsealing the user keys 152. The SRK 150 is required to decrypt the sealed storage 154, and the sealed storage 154 is never available on the disk 12 in an unencrypted format.

In various implementations the SKS module 140 provides one or more application programming interfaces (“APIs”) 156. In some implementations, the one or more APIs 156 allow users to create keys 152, store keys 152, and retrieve keys 152. Various additional APIs 156 are possible as will be described further herein and as would be appreciated by those of skill in the art.

In some implementations, an API 156 may be provided to deny access to the module 140 or other programming if proper credentials are not provided. An API 156 may be provided to translate obfuscated key(s) 152 and/or certificate(s) into a standard format. A further API 156 may be provided to store and retrieve key(s) 152 and/or certificate(s).

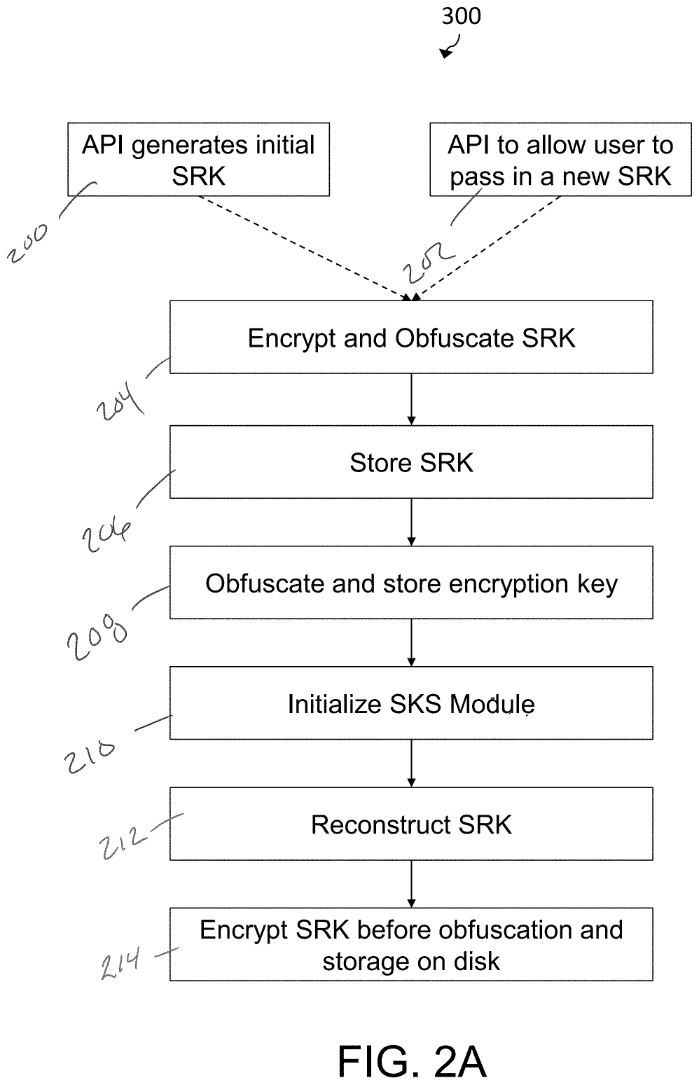

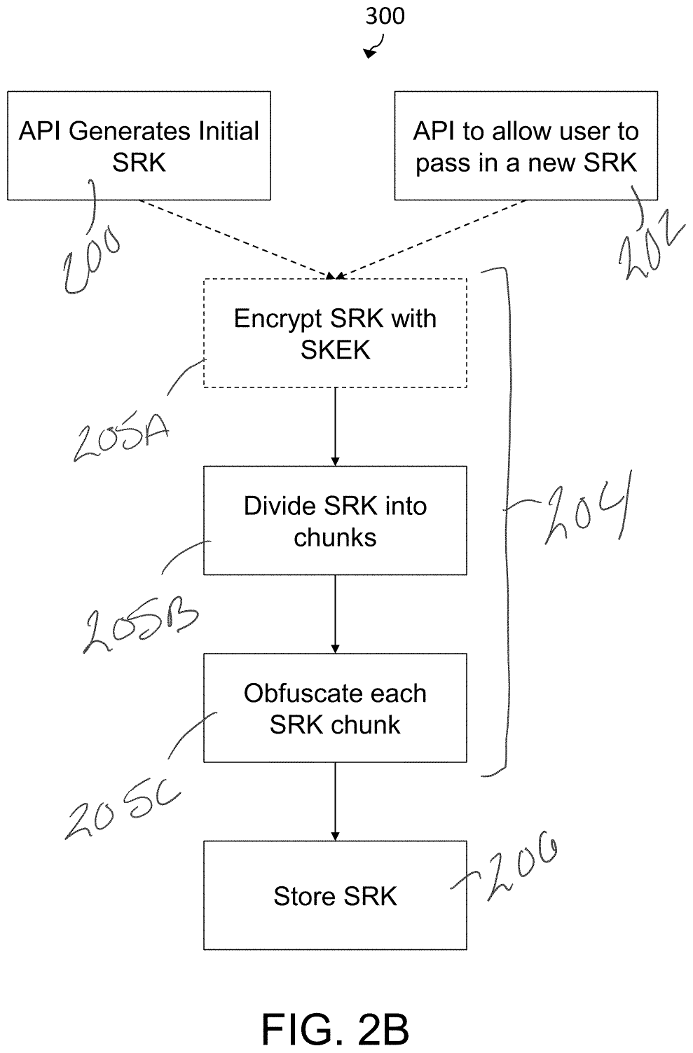

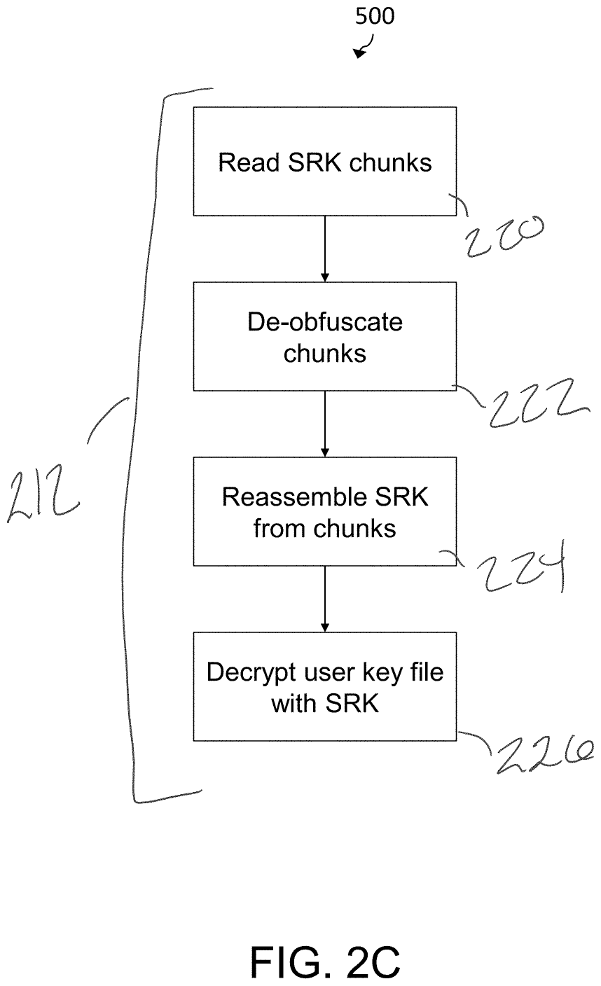

Turning to FIGS. 2A-2C, in various implementations the SKS module 140 may be constructed and arranged to execute a series of steps and substeps, each of which is optional and may be performed in any order or not performed at all. In some cases, the SKS module 140 provides an API 156 to generate a new SRK 150 (box 200). In some implementations, this API 156 is only used to create an initial SRK 150. In implementations where an SRK 150 already exists, an error may be returned.

As an alternative, in some cases the SKS module 140 provides an API 156 allowing a user to pass in a new SRK 150 (box 202). In various implementations, it is appreciated that a user may be a person, application, task, program, or other mechanism for accessing the system 100.

In a further optional step, the SRK 150 is encrypted and obfuscated (box 204). In some implementations, the SRK 150 is encrypted with a static key encryption key (“SKEK”). In another optional step, the SRK 150 is then stored on the disk 12 or other file system (box 206). As will be appreciated, the SRK 150 is only saved/stored after being encrypted and obfuscated.

FIG. 2B depicts possible steps for encrypting and obfuscating the SRK 150 according to various implementations, shown for example in FIG. 2B, after either the API 156 generates an initial SRK 150 (box 200) or an API 156 allows a user to pass in a new SRK 150 (box 202), the SRK 150 is encrypted and obfuscated (box 204). In various of these implementations, the SRK 150 is optionally encrypted with a SKEK (box 205A). The encrypted or unencrypted SRK 150 may then be divided into chunks (box 205B). In another optional step, each chunk of the SRK 150 may then be obfuscated (box 205C) via any known method and as will be discussed further below. The optionally encrypted and obfuscated SRK 150 may then be stored (box 206). In various implementations, the processes shown in FIG. 2B are executed upon the first initialization of the SKS module 140.

Turning back to FIG. 2A, in some cases, the SKEK may be obfuscated and stored in one or more chunks (box 208). In some implementations, the SKEK is stored in at least four chunks. In various implementations, each chunk of the SKEK is stored in a static variable as part of the system 100. Each static variable is stored with a name that does not reveal the purpose of the variable. In one example, a first variable may be titled SKS err count and a second variable may be titled SKS tmp. Further in some implementations, the variables may be stored in non-contiguous memory. Each of these optional sub-steps can help prevent the SKEK from being easily discovered by a scan of the binary code image or by memory scans if the device has been compromised by a hacker.

In various implementations, the SKS module 140 is initialized (box 210). In another optional step, the SKS module 140 reconstructs the SRK 150 (box 212) from the obfuscated form. The de-obfuscated SRK 150 can be used to unseal/decrypt the storage 154 and/or the user keys 152.

FIG. 2C depicts possible steps for reconstructing the SRK 150. In various implementations, shown for example in FIG. 2C, the system 100 can be authenticated upon initialization of the SKS module 140 by recreating the SRK 150. In various implementations, the SRK 150 is reconstructed 212 via a series of steps each of which is optional and may be performed in any order or not at all. In one optional step, the system 100 begins reconstructing the SRK 150 by reading the SRK chunks (box 220). In a further optional step, the chunks are de-obfuscated (box 222). In a still further optional step, the system 100 reassembles the SRK 150 from the chunks (box 224). In various implementations, the reassembled SRK 150 may then be used to decrypt a user key file (box 226).

Turning back to FIG. 2A, in some cases, the SRK 150 is again encrypted and obfuscated before storage on the disk 12 (box 214). In a further optional step, the SRK 150 may be exportable, in an encrypted format, via an API 156. In these and other implementations, an API 156 is provided to allow users to export the SRK 150, in an encrypted format, for external backup. The system 100 may additionally provide an API 156 allowing for importation of the exported SRK 150 for recovery.

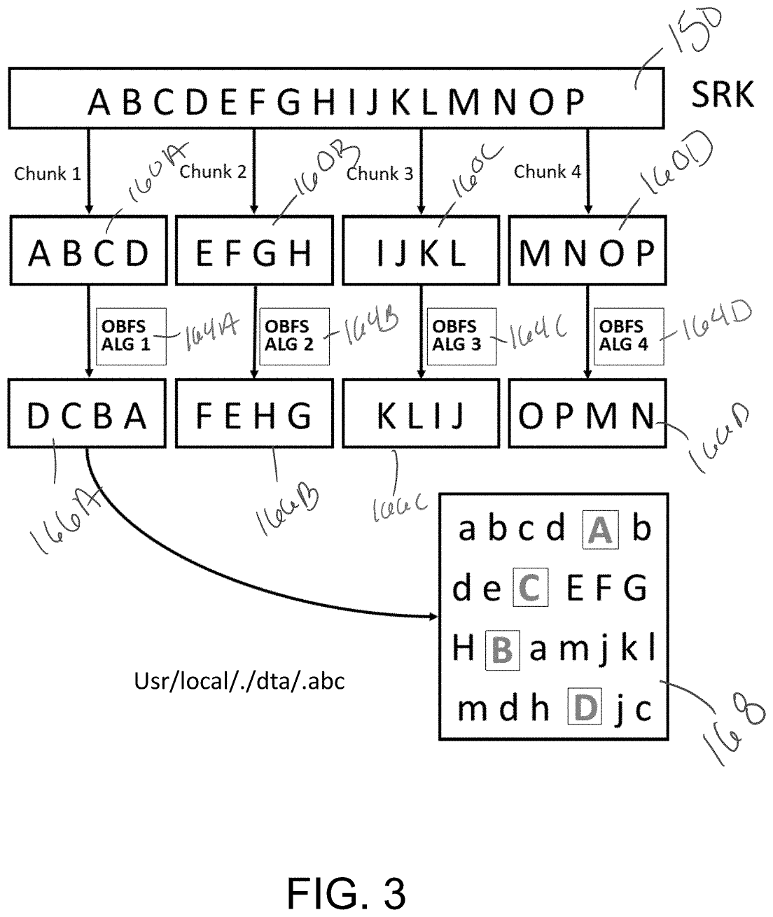

FIG. 3 shows a technique for obfuscating the SRK 150 in various implementations. In these implementations, the SRK 150 is broken into multiple chunks 160A-D, for example four or more chunks 160A-D. In an optional sub-step, the bit order of the chunks 160A-D is scrambled via an obfuscation algorithm 164. resulting in corresponding obfuscated chunks 166A-D. As shown in FIG. 3, in some implementations, a different obfuscation algorithm 164A-D is used for each of the chunks 160. In various implementations, a user may determine which obfuscation algorithm 164 is used for each chunk 160 via #defines, a directive that allows the definition of macros within source code, or other appropriate coding technique. In these implementations, each original equipment manufacturer (“OEM”) can have a customized implementation, such as to ensure that knowledge of the obfuscation algorithm(s) 164A-D does not allow a user to discover the SRK 150.

In a further optional sub-step, the scrambled or obfuscated chunks 166A-D are stored on the disk 12 or other file system in hidden files 168 with file names that do not reveal the content of the files 168. In such cases the chunk files 168 may be considered to be “hidden” files.

In various implementations, the scrambled or obfuscated key chunks 166A-D are stored in the files 168 in an obfuscated fashion. For example, for a chunk 160A, 166A that is 32 bits long, the storage file 168 may have at least about 320 bits of data. In some implementations, the data file 168 is stored in a location within the file that is deterministic but is not easily discovered. In some implementations, the files 168 are stored in flash memory in fixed locations known to the SKS module 140.

In various implementations, the SRK 150 can be reassembled by reversing the steps described above and shown in FIG. 3.

In various implementations, the files 168 have user permissions set to minimize the risk of third-party users or unauthorized users modifying and/or deleting the files 168. In some implementations, a guide is provided to allow users to implement the SKS module 140 and system 100 and set appropriate file 168 permissions.

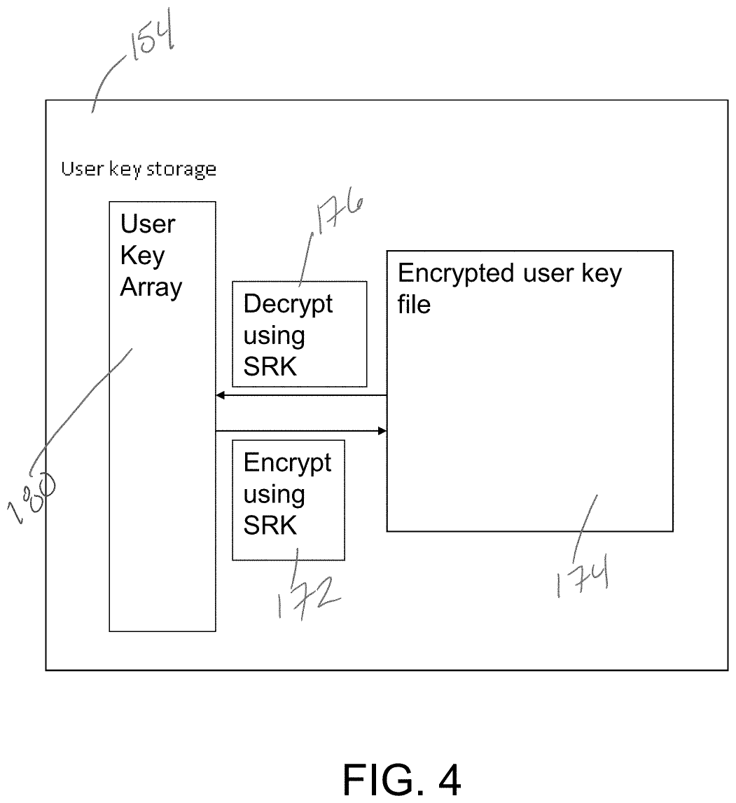

Turning to FIG. 4 is a schematic depiction of key encryption processes according to various implementations. In the depicted example, the SKS module 140 encrypts 172 user keys 152 to store them on the sealed storage or file system 154 on an encrypted user key file 174. In various implementations, the SKS module 140 maintains an array of user key data structures 180. In some implementations, an entire array 180 or other grouping of user keys 152 are encrypted 172 with the SRK 150 before being written to the disk 12. In these implementations, each time the array 180 or other grouping is updated it will be encrypted 172 and written to the disk 152.

As described above, when the SKS module 140 is initialized, the SKS module 140 will read the user key file 174 and decrypt 176 the encrypted user key file 174 using the SRK 150.

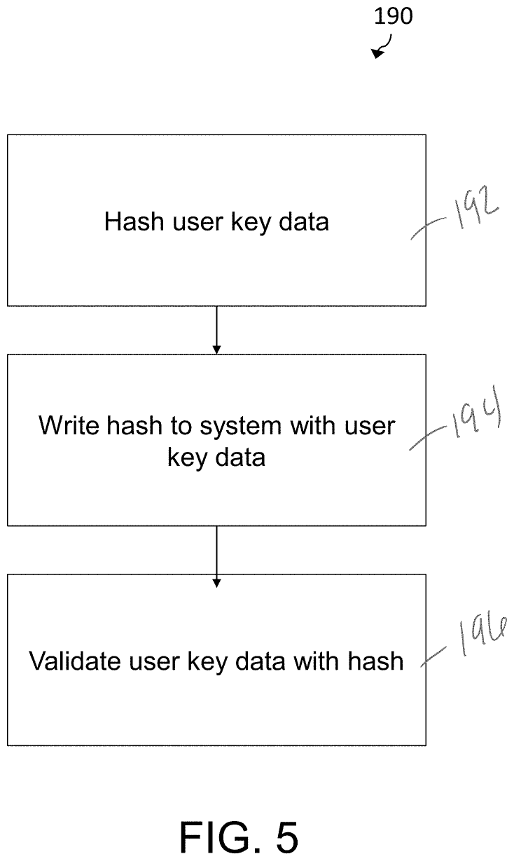

Turning to FIG. 5, a flowchart of a hash function is illustrated according to various implementations. As shown, the system 100 or the SKS module 140 may create a hash of the user key array 180 (box 192). The hash may be stored in the file system along with the encrypted user key file 174 (box 194). In these implementations, the hash can be used to validate that the user key data 180 has not been tampered with or modified when it is read from the disk 12 (box 196).

In some implementations, the SKS module 140 stores two copies of the SRK chunk files 168 in different locations on the file system. These SRK chunk files 168 may include a cyclic redundancy check (“CRC”) or hash for validation. In these implementations, if the main or primary SRK chunk files 168 are missing or corrupt, such as if an invalid CRC or hash is returned, the system 100 may attempt to recover the missing and/or corrupt chunk files 168 from the backup or secondary files.

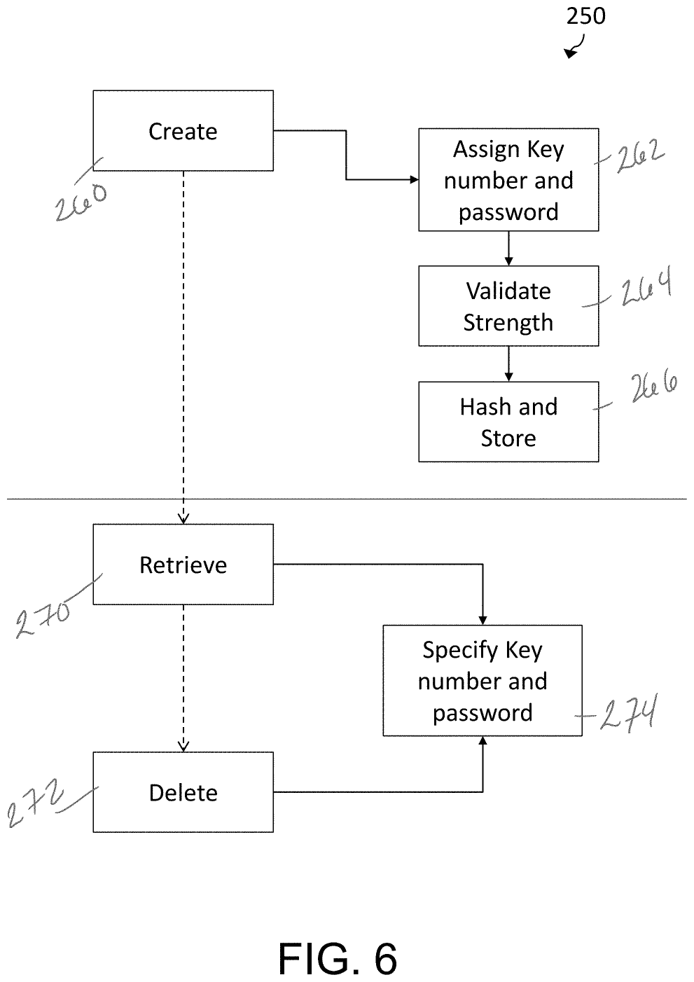

Turning to FIG. 6, the SKS module 140 may provide an API 156 or set of APIs 156 to manage SRKs 150 and user keys 152. FIG. 6 is a flow diagram illustrating some example APIs 156 that the SKS module 140 may provide, such as APIs 156 for Create 260, Retrieve 270, and Delete 272. In some implementations, user keys 152 may be identified with a key number and a user ID, such as a text string. Users, including tasks and processes, manage the key numbers and key passwords. In various implementations, with the Create API 260, the user will assign 262 the key number and key password. In another optional step, the Create API 260 and SKS module 140 will validate 264 the password strength. Additionally, in a further optional step, the password can be hashed 266 and the hash stored on the file system or disk 12. In some implementations, the hash may be a SHA256 hash. In these implementations, the passwords themselves are not stored.

For the Retrieve 270 and Delete 272 APIs, the system 100 may require that the user specify a proper key number and key password. In an example where the password does not match the stored password, the API call will return an error and report the error using the library error logging APIs 156.

In various implementations, the system 100 supports a cryptographic challenge-based API 156, such as an RSA challenge, to validate users calling the APIs 156. In these implementations, the users may use password-based API validation or RSA challenge-based validation.

In some implementations, the SKS module 140 may be configured to support multi-threading. For example, semaphore and/or other OS locking primitive may be used to enable multi-threading. In some implementations, the call to the OS primitive is wrapped with the library call to ensure portability.

In various implementations, the SKS module 140 may provide a build option allowing for utilization of either a proprietary crypto library or a crypto library already available on the platforms such as the open SSL crypto library.

In various implementations, the SKS module 140 may be integrated with a hardware security module. In these and other implementations, the APIs 156 discussed above may remain the same, while the SRK 150 and optionally other user keys 152 are stored using a hardware security module.

In implementations, supporting a hardware based trusted execution environment such as, TrustZone® or other trusted execution environment the SRK 150 can be stored in the “secure world” provided by TrustZone®. In some of these implementations, the SRK 150 may additionally be obfuscated, as described above.

In some implementations, an API 156 is provided to allow a user to request a new SRK 150 be generated. When a new SRK 150 is generated the sealed storage 154 must be unsealed using the old SRK then resealed using the new SRK 150. In various implementations, only authorized users may access and call these APIs 156.

In further implementations, an API 156 is provided to allow a user to pass in a new SRK 150. In these implementations, the sealed storage 154 is released or otherwise decrypted using the old SRK and then resealed with the new SRK 150. Only authorized users can access and call these APIs 156.

In some implementations, the SKS module 140 may be ported to a real time operating system (“RTOS”), for example ThreadX® or FreeRTOS.

Although the disclosure has been described with references to various embodiments, persons skilled in the art will recognized that changes may be made in form and detail without departing from the spirit and scope of this disclosure.

What is claimed is:

1. A method for obfuscating keys comprising:
dividing a key into at least two initial chunks;
processing each of the at least two initial chunks with at least one obfuscation algorithm to create at least two obfuscated chunks; and
storing each of the at least two obfuscated chunks in a storage file.

2. The method of claim 1, further comprising inserting random data into the at least two obfuscated chunks via at least one API.

3. The method of claim 1, further comprising inserting hardware specific data into the at least two obfuscated chunks via at least one API.

4. The method of claim 1, further comprising using a different obfuscation algorithm for each of the at least two initial chunks.

5. The method of claim 1, further comprising storing a hash value for the key.

6. The method of claim 5, further comprising validating the key using the hash value.

7. The method of claim 1, further comprising customizing the number of chunks.

8. A system for storing and protecting user keys comprising:
(a) an Internet of Things (“IoT”) device;
(b) a disk within the IoT device;
(c) a module disposed on the disk comprising:
(i) at least one storage root key; and
(ii) at least one user key; and
(d) at least one API in communication with the disk,
wherein the storage root key is encrypted with a static key encryption key, and
wherein the storage root key is stored on the disk in an obfuscated format and in an obfuscated location.

9. The system of claim 8, wherein the at least one API allows a user to store a user key.

10. The system of claim 8, wherein the at least one API allows a user to retrieve a user key.

11. The system of claim 10, wherein the at least one API verifies the user is an owner of the user key before allowing the user to retrieve the user key.

12. The system of claim 8, further comprising a library comprising a plurality of encrypted and stored user keys.

13. The system of claim 12, wherein the system hashes the library to create a hash value and wherein the hash value is stored on the disk for validating the plurality of encrypted and stored user keys in the library.

14. The system of claim 8, wherein the at least one storage root key and the at least one user key are not stored on the disk in an unencrypted format.

15. A method for protecting one or more keys comprising:
encrypting a first key with a second key;
storing the first key in an encrypted format on a disk; and
storing the second key on the disk in an obfuscated format and an obfuscated location.

16. The method of claim 15, wherein the first key and the second key are not stored on the disk in an unencrypted format.

17. The method of claim 15, further comprising hashing the second key to create a hash value, storing the hash value on the disk, and validating the second key using the hash value.

18. The method of claim 15, wherein the second key is stored in a secure element.

19. The method of claim 18, wherein the secure element is a trusted platform module.

20. The method of claim 18, wherein the secure element comprises a trusted execution environment.
